(19) United States
(12) Patent Application Publication
(10) Pub. No.: US 2017/0169524 A1
(43) Pub. Date: Jun. 15, 2017

(54) REGIONAL MANUFACTURE AND ASSEMBLY OF VEHICLE AND VEHICLE STRUCTURE

(71) Applicant: Martin Geoffrey O'Connor, South Chailey (GB)

(72) Inventor: Martin Geoffrey O'Connor, South Chailey (GB)

(21) Appl. No.: 15/418,862

(22) Filed: Jan. 30, 2017

Related U.S. Application Data
(60) Provisional application No. 62/299,028, filed on Feb. 24, 2016.

(51) Int. Cl. G06Q 50/04; G06Q 10/08; B62D 65/00; G06Q 30/06

(52) U.S. Cl. CPC G06Q 50/04; G06Q 30/0635; G06Q 10/083; B62D 65/00

(57) ABSTRACT

A system and method for regional manufacture and assembly of vehicles and vehicle structures. The method includes manufacturing a vehicle structure (BIW) at regional locations, delivery of vehicle structure to points of sale (POS), delivery of remainder of vehicle parts and components to POS, installing vehicle structure into a production vehicle, completing assembly of production vehicle, and final testing of production vehicle for sale.

### CROSS REFERENCE TO RELATED APPLICAITONS

This application claims priority to U.S. Provisional Application 62/299, 028 filed Feb. 24, 2016. The entirety of that Application is hereby incorporated by reference.

### STATEMENT REGARDING FEDERALLY SPONSORED REASEARCH AND DEVELOPMENT

Not Applicable

### REFERENCE TO SEQUENCE LISTING

Not Applicable

### FIELD OF THE INVENTION

The invention relates to vehicle assembly at POS sites, and more particularly to methods and systems for interactive BIW manufacturing through the operation of regional manufacturing sites in proximity to POS outside of an Original Equipment Manufacturer (OEM), or Contract Manufacturer (CM) Conventional Assembly Plant (CAP).

For purposes of this invention an automotive Point-Of-Sale (POS) is a place at which an automotive transaction takes place. Also referred to as a point of purchase, or point of physical vehicle delivery or vehicle pickup by a customer, a POS can involve a variety of meanings including but not limited to:
An authorized automobile, autocycle, and self-driving vehicle service center or repair facility including mechanical and collision centers
Owned and/or directly operated by an OEM and/or 3rd parties
A dealer, independent franchise dealer, franchise dealer, OEM owned store, gallery, store, sub-dealer, distributor, dealership operating company, dealership and/or dealership property, terms of which often used interchangeably within the automotive industry
Single or multi brand (franchise) centers
Virtual dealer sites with or without vehicle inventories
New vehicle processing or preparation facilities (imported vehicles)

### BACKGROUND OF THE INVENTION

It is a widely acknowledged and reported that the global automotive industry's overall Return on Invested Capital (ROIC) is generally below its Weighted Average Cost of Capital (WACC). This situation is caused in large part by capital spending for mandated global regulations including safety requirements, emissions legislation and new energy systems all of which are not uniform throughout the world and changing consumer requirements including autonomous vehicles, new energy vehicles and ride sharing. The majority of these capital expenditures are incurred by the OEM due predominately to the use of conventional BIW fabrication and assembly process within the CAP virtually unchanged over the last 80 years. While the term “BIW” is typically used within the automotive industry to denote a vehicle body structure after assembly, excluding the exterior body panels and prior to corrosion protection and painting, in this context BIW refers to the entire vehicle body structure including exterior body panels, closures and trim collectively supplied with applicable corrosion protection/paint/color coatings. Accordingly each OEM maintains its exclusive BIW manufacturing process rarely shared with other OEMs.

A CAP typically consists of three operations generally in series:
BIW fabrication/assembly;
BIW corrosion protection/painting/coloring; and
Final vehicle assembly/testing (Commonly referred to as Trim, Chassis and Final or TCF)

The BIW is generally fabricated, assembled and painted first within a CAP and sequenced and matched with the corresponding vehicle components before TCF. Traditionally a CAP is configured to produce on average 250,000 vehicles per year or approximately 1 vehicle/minute over a 16-hour day. Most recently OEMs endeavor to increase the scale of the CAP by operating variations of three crews-two shifts or three crew-three shifts. The remaining vehicle's mechanical and electrical components and subsystems are generally purchased from outside the CAP from approximately 300-400 final suppliers, commonly referred to as Tier 1s and system integrator/sequencers, commonly referred to Tier 0.5s. Third Party Logistic Companies (3PLs) designated by the OEMs deliver the components and subsystems on a just-in-time (JIT) or just in sequence (JIS) basis for final vehicle assembly and test.

In 2015, virtually all vehicle BIWs globally were fabricated from either ferrous materials including high strength steels, non-ferrous materials including aluminum, or a combination of both. In either case the BIW process comprises a capital-intensive process including stamping, welding, framing, assembly, corrosion and final painting, repair and repainting if required, and disassembly of certain closures for parallel assembly prior to final assembly of the vehicle. The BIW operation as described, accounts for over 50% of the OEMs' overall capital investment in a given CAP amounting to $300 Million-$750 Million depending upon whether a CAP is newly opened, or an existing CAP is modified, due to a vehicle new model change or plant product reallocation.

Given the current traditional processing layout of the OEM's CAP the BIW must be fabricated, assembled and painted in a given configuration or body styles before the vehicle is assembled and tested. The BIW generally determines the final sequencing of the overall vehicle assembly and generally OEMs will provide a buffer of BIWs, normally ranging from 100-400 units prior to TCF.

TCF follows a predominately manual serial process of approximately 900 assembly stations. Typically major components such as engines, transmissions, chassis and drive train are assembled by off-site suppliers and delivered to the CAP as a complete subsystem. Other parts are assembled near or within the CAP by system integrators or sequencers such as seating, exhaust systems and bumper fascias.

In the U.S. as result of decades old individual state franchise laws, virtually all new vehicles whether assembled locally or imported, must be sold and delivered thru a POS referred to as the independent franchise dealer (IFD). While a customer can configure online a preferred vehicle with the exact features desired and then place an order either directly with an IFD, directly with the OEM or through a third-party, who helps customers navigate the vehicle buying process, a customer cannot “purchase” a vehicle directly from most major OEMs. In 2015 there were approximately 16,600 IFDs, or “brick and mortar sites” in the U.S., selling on average 1,000 new vehicles each year or approximately 3-4 per day. The U.S. IFD system has been employed with certain regional variations in other markets.

The IFD is generally invoiced for vehicle as soon as it leaves the CAP. Accordingly, the automotive market is predominately segmented between two types of final customers or buying units including final retail customers purchasing or leasing vehicles for personal use which comprise approximately 78% of the market, and fleet and rental customers including special vehicle manufacturers which comprise the remaining of 22% of the overall market. The customer has the option of buying a vehicle from the IFD's inventory or placing a custom factory order. The IFD orders vehicles through the specific OEM's computerized vehicle ordering system, which not only allows the IFD to specify models and options, but also to check on the status of orders already in progress and make last-minute changes to vehicle that aren't already on the final CAP assembly line.

There can be a significant period of time from when an IFD places a factory order on behalf of a customer to the time that the vehicle is delivered. Typically vehicles are shipped by rail when the IFD is more than one day away from the CAP and by truck less than one day. The distribution system introduces significant delays and variability into the timeliness of delivery of vehicle and in-transit damage is common.

Due to the high fixed costs of the CAP, OEMs strive to maximize output and provide significant economies of scale. However, operating at high scale volume does not allow for any reduction in time to deliver vehicle and contributes to considerable large and expensive inventory pipeline between the CAP and IFD. This inventory may average approximately 60-90 days or approximately 3 million to 4.5 million vehicles on a given day throughout the U.S. Overall between 20%-30% of the cost of a vehicle may be accounted for after the vehicle leaves the CAP.

In certain situations OEMs have utilized outside 3rd parties, commonly referred to as contract manufactures (CM), to assemble niche or low volume vehicles on behalf of the OEM outside of their CAPs. The OEM manages the vehicle design and material procurement processes while the CM generally will manage the logistics process, assemble, test and ship the vehicles thru the normal distribution system. The larger CMs essentially invested in their own CAPs and are responsible for the up-front investment that normally the OEM would have incurred if a vehicle platform were built within the CAP.

The considerable and increasing capital investment requirements to facilitate and update CAPs and the resulting inherent cost of distribution over the long run contributes to the inability of the automotive industry in general to maintain a ROIC above its WACC.

Additionally new OEMs, either local domestic firms or overseas companies, seeking to enter an automotive market face high barriers to entry in terms of substantial upfront capital costs or in the case of importers the costs associated with establishing vehicle homologation and a sales/distribution system.

Therefore the present invention seeks to provide methods and systems for the separation of the BIW manufacturing from the CAP and the economical and real time on-demand assembly of vehicles at POS. These and other objects of the invention will be apparent to those skilled in the art from the description that follows. It would be desirable therefore to provide a method and system for interactive vehicle structure manufacturing and vehicle assembly that overcomes these and other disadvantages.

### BRIEF SUMMARY OF THE INVENTION

The methods and the systems of this invention center around the innovative concept of addressing the above problems associated with the present manufacturing, assembly and delivery of BIW and the coordinated assembly and delivery of a vehicle.

Accordingly, an object of the invention is to reduce the high level of capital investment and operational costs that are customarily present in a CAP facility by separating the manufacture of BIW from the CAP and, in parallel and localizing the assembly of a vehicle to regional POS sites throughout an automotive market. A centralized ordering system facilitates the manufacturing and delivery of the BIW on a JIT or JIS basis as ordered at the POS for final assembly into a vehicle.

A further object of the present invention is to enable the local assembly and delivery of a new vehicle to a particular customer's preferences at the individual POS with a high level of flexibility and customization, comparable to that of a low volume niche vehicle supplier, but with the ability to deliver the vehicle within significantly shorter timelines.

The invention is aimed principally at new retail customers and consequently is geared toward maximizing the flexibility and range of vehicle customization rather than production rate. In another embodiment, the invention is aimed at rental, fleet and commercial customers. In still another embodiment the invention is also aimed at POS customers.

One aspect of the present invention is directed to a centralized command and control network system for the automated manufacture and fabrication of BIW. The system comprises a centralized control system, which oversees the manufacture of the BIW throughout various regional sites within an automotive market. The centralized control system comprises an OEM specified vehicle bill of material (BOM), a processor, a network connection, and instruction code for an automated manufacturing process for creating a specific BIW for a customer based upon the customer's preferences.

The BIW manufacturing system is to be understood as being substantially automated after the system receives a BIW order from a POS. After the customer has placed the order at or with the POS the inventive manufacturing system will then manufacture the BIW upon receipt of the order in an automated manner without requiring further substantive manual intervention or reliance upon the vehicle assembly.

The inventive system also comprises automated programmable BIW manufacturing equipment networked to the centralized control system via the OEM vehicle ordering system. The manufacturing equipment is configured for manufacturing, in-mold or in-line decoration and sub-assembly of BIW.

Another aspect of the present invention is directed to the assembly and test of vehicle at POS thru a centralized command and control network system. The system comprises a centralized control system, which oversees the assembly of vehicles throughout specific POS within the market. The centralized control system comprises a vehicle BOM, a processor, a network connection, and instruction code for an automated assembly process for creating a specific vehicle for a customer based on the customer's preferences.

A clear understanding of the key features of the invention summarized above may be had by reference to the appended drawings, which illustrate the method and system of the invention, although it will be understood that such drawings depict preferred embodiments of the invention and, therefore, are not to be considered as limiting its scope with regard to other embodiments which the invention is capable of contemplating.

### BRIEF DESCRIPTION OF THE DRAWINGS

FIG. 1 illustrates a process flow diagram showing the overall BIW and vehicle ordering, assembly and delivery process for assembling a vehicle for a new retail, fleet/rental or specialty customers with an aspect of the present invention;

FIG. 2 illustrates a process chart showing the overall BIW and vehicle coordinated manufacturing, assembly and delivery process times for a platform volume of 50,000 vehicles/year across an illustrative cohort of 250 POS;

FIG. 3 illustrates a process flow diagram for the assembly of BIW and related components at POS in accordance with present invention;

FIG. 4 illustrates a process flow process diagram for the trim, chassis and final assembly and test of vehicle at a POS in accordance with the present invention.

### DETAILED DESCRIPTION OF THE INVENTION

An illustrative embodiment of the system and method of the present invention is described below. In the interest of clarity, not all features of an actual implementation are described in this specification. It will of course be appreciated that in the development of any such actual embodiment, numerous manufacturing and assembly decisions must be made to achieve an OEM's vehicle specifications. Moreover, it will be appreciated that such a development effort might be complex and time-consuming but would nevertheless be a routine undertaking for those skilled in the art or science to which the invention pertains to make and use the same. It should be understood that some of the steps may be supplemented with additional steps or that the order of some of the steps may be changed without deviating from the inventive concept. It should further be understood that the inventive concept might be applied to other types of assembly processes such as body-on-frame, monocoque, unibody and rolling chassis company referred to as a “skateboard” assemblies or various component sub-assemblies.

In one such illustrative embodiment the economic scale is 50,000 vehicles and 55,000 BIW components (including 5,000 individual BIW components for potential collision service and repair) per calendar year. Accordingly a cohort of 250 POS each assembling two vehicles/day would yield the economic scale of 50,000 vehicles/year in this illustrative embodiment.

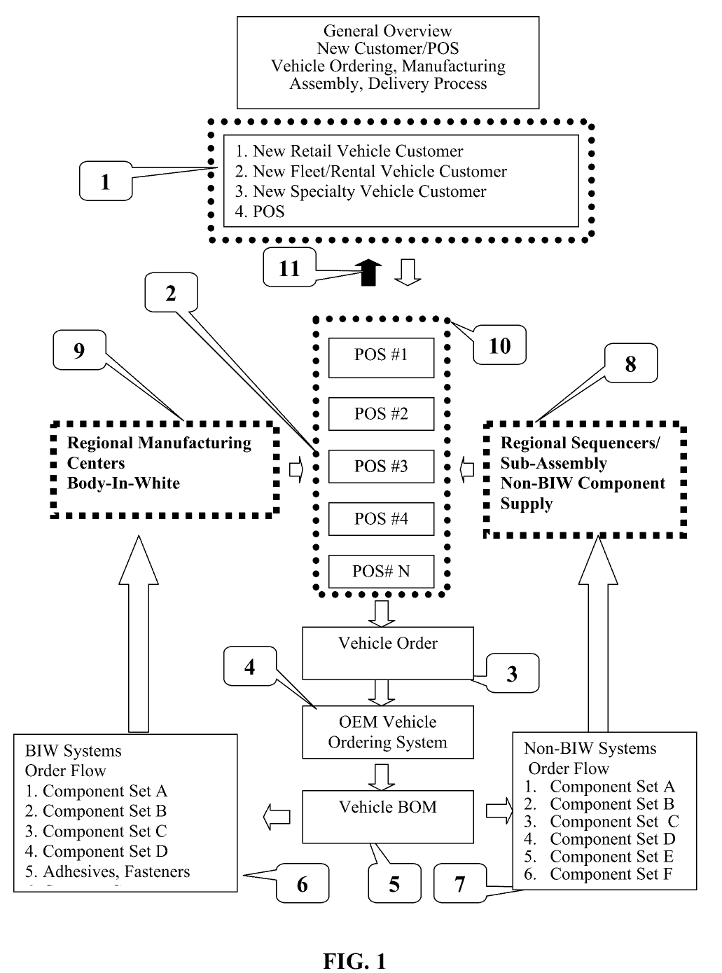

FIG. 1 is an illustrative operating embodiment of the present invention. A customer (1) including but not limited to a retail customer, rental/fleet, specialty customer is shown interfacing with a particular POS (2). For the purposes of this diagram refer to POS #3 as the Designated POS. Additionally a POS may also order vehicles for display, inventory or sale to another POS. This interfacing may take place in person, at the POS, by phone, online or thru the OEM, independently or in conjunction with various POS online buying sites. New customers conduct an information process of gathering data and pricing regarding their pending decision about a vehicle they would purchase or lease including vehicle specifications, options, pricing, and performance data.

Upon the customers' final review and approval of a specific vehicle, an order (3) is placed at Designated POS within the OEM Vehicle Ordering System (4) which is tied to a specific Bill of Material (BOM) (5). The vehicle BOM is then segmented into two individual material and component orders including BIW Systems Order Flow (6) and Non-BMW Systems Order Flow (7) which comprise other vehicle mechanical and electric systems.

While a vehicle can be defined technically in various ways as being segmented into specific subsystems and components, the nomenclature BIW Systems, depicted in FIG. 1 will be used to denote those BIW structures and components that are color-coded and matched depending upon a vehicle order.

The Non-BIW components as specified within the BOM are shipped (8) to designated regional sites and sequencers or direct to the designated POS in accordance with a customer's order. Depending upon the type, common components may be shipped in batch to the Designated POS and other non-common parts may be shipped JIT or JIS to the Designated POS at which the customer order originated.

The BIW components as specified within the BOM (9) are shipped in parallel to regional manufacturing centers or direct to the Designated POS and prepared in accordance with the customers vehicle order, including body style, exterior paint and matching exterior trim.

The shipment of both BIW and non-BIW components originate from the regional sites to the Designated POS. In one embodiment the complete BIW is fabricated at regional sites. In another embodiment certain BIW components may be outsourced to a third party for fabrication. In still another embodiment the BIW may also be assembled at the regional sites or at the Designated POS.

At the Designated POS the BIW and vehicle are assembled (10) in accordance with the customer's order and the vehicle purchase process is completed (11).

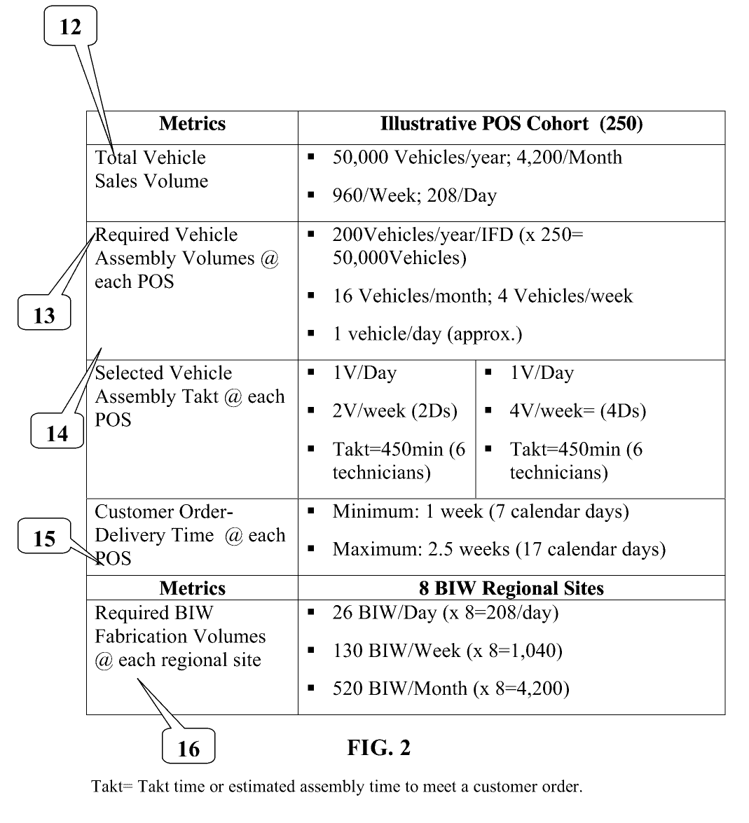

Referring to FIG. 2 the chart encompasses the key operating metrics including the approximate process times (Takt times or the estimated time to meet a customer order). As referenced in FIG. 1 an illustrative embodiment involving a Total Vehicle Sales Volume of 50,000 vehicles (12) is shown.

Given a cohort of 250 POS a Required Vehicle Assembly Volume (13) of 4 vehicles/week or approximately 1/day fulfills the total vehicle sales volume demand of 50,000 vehicles annually.

The Selected Vehicle Takt time at the POS is approximately 450 minutes (14). In one such illustrative embodiment the assembly may include 6 technicians for a total of 45 man-hours of labor required to assemble one vehicle.

The estimated Order-To-Delivery time (15) is between one week and two weeks depending upon material delivery and technician reallocation.

The matching BIW fabrication volumes given a cohort of 8 regional sites is 208/day (16) to fulfill both the POS customer volume and any parts required for collision body repair.

The illustrative cohort of 250 POS (12) can be ramped up top meet customer demand in a given market. In one such embodiment a lead POS is designated to install assembly equipment and provide process validation, early production start-up and final “regular volume” run rate. Subsequently additional POS are then released to install equipment and validate the assembly process in accordance with lead POS.

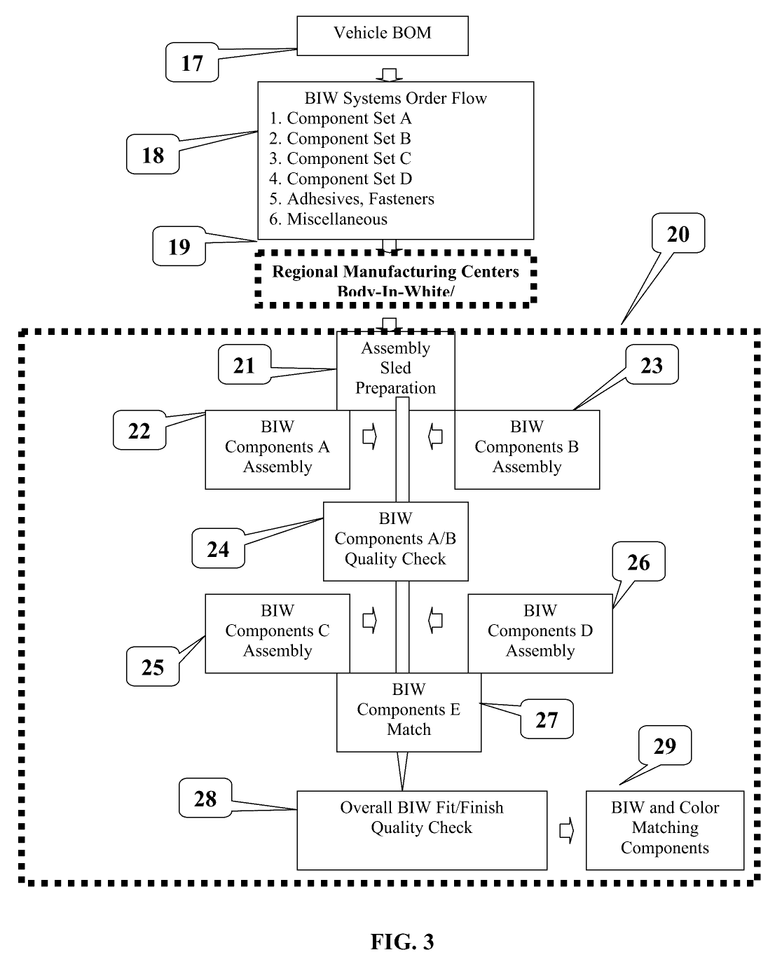

In FIG. 3 the assembly process of BIW is shown as performed at a designated POS by technicians by means of a specific manual assembly procedure. A technician is any person that interacts with the manual assembly process at the POS. In one embodiment, the technician is a person employed by the POS to service vehicles. In another embodiment the technician is an assembly manager. The OEM vehicle BOM (17) as discussed with reference to FIG. 1 specifies the type of body styles and related components (18) required for this assembly process. BIW assembly is conducted in to suit modular sub-assembly and component delivery formats dependent upon the OEM and vehicle BOM.

The Regional Manufacturing Centers (19) fabricate BIW components in accordance with the vehicle BOM and deliver the components to Designated POS site (20) in accordance with a customer order.

In one embodiment individual BIW component sets are delivered to the POS. In another embodiment components and sub-assembles are delivered to the POS. In still another embodiment a complete BIW assembly may be delivered to the POS.

The POS technicians prepare to commence the BIW assembly process by arranging an assembly sled with jigs and fixtures (21) that allow the technicians to maneuver the skid thru various specified assembly stations. Typically, specifically designed assembly jigs and fixtures provide a secure way of attaching the various BIW components together. In one embodiment an 8 station manual assembly process provides for the complete assembly and test off one BIW. In another embodiment the manual assembly process is 10 stations.

BIW Component Set A is affixed and assembled (22) to the assembly sled (21) by technicians. In parallel BIW Component Set B is also affixed and assembled (23) to the assembly skid by technicians.

Proceeding to the next step a quality assurance check (24) is made of the BIW assembly. Typically a fit and finish check is conducted to determine if the BIW assembly has meet OEM standard procedures for measuring the total dimensional variation and paint finish of each BIW as it is assembled. Fit and finish represents a subjective method of characterizing the total dimensional variation of a vehicle in terms of the sizes and gaps between adjacent BIW surfaces and the flushness of different BIW surfaces.

BIW Component Set C is affixed and assembled (25) to the assembly sled (21) by technicians. In parallel BIW Component Set D is also affixed and assembled (26) to the assembly skid by technicians.

BIW Component Set E is matched (27) with the BIW assembly. Typically not all BIW components are assembled to the BIW structure allowing for a more efficient employment of TCF assembly operations.

A final BIW fit and finish check is preformed (28). Conventional vehicle final BIW quality fit and finish techniques are well known in the industry and at POS and therefore will not be further discussed.

The final BIW is then mated (29) with other BIW parts for color matching purposes. The BIW assembly proceeds to the TCF assembly operation within the POS.

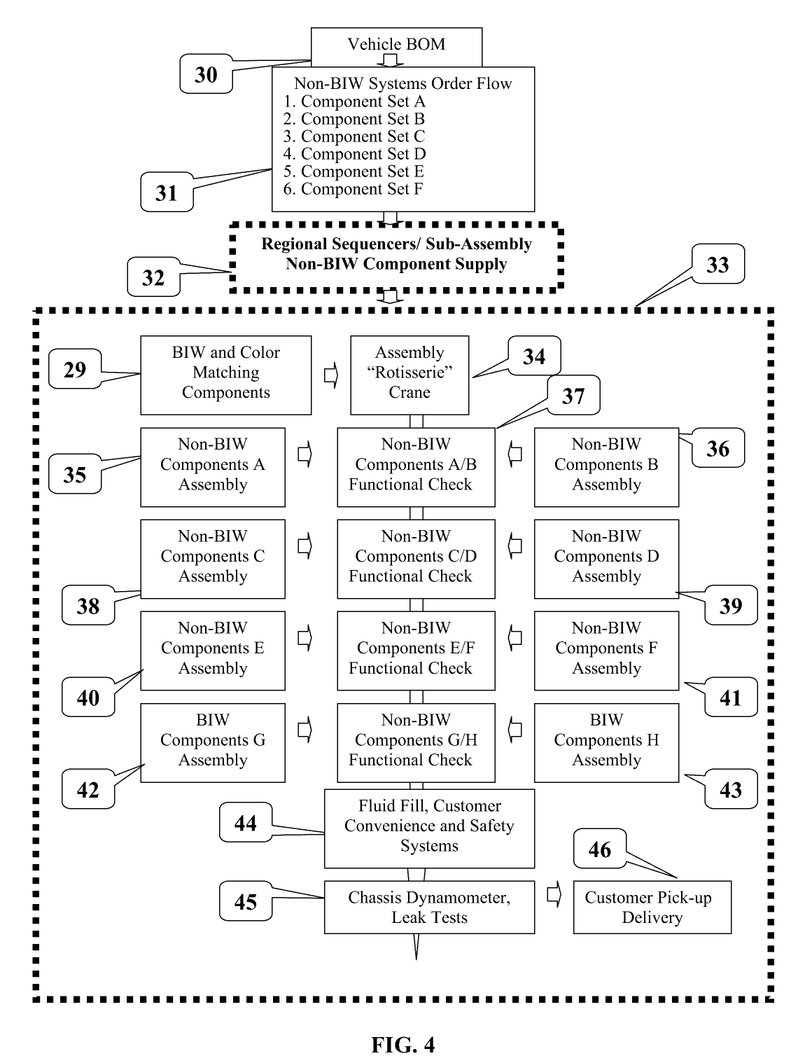

FIG. 4 is a process flow diagram of a manual assembly method in accordance with an embodiment of the present invention. For illustrative proposes a two-door body style, as referenced in FIG. 2, is shown.

At referenced in FIG. 1 the Vehicle BOM orders all non-BIW components (30) and the various mechanical and electrical components sets (31) are normally assembled and inventoried at regional sequencers (32). Depending upon the type of components common components may be shipped in batch to the designated POS and other non-common parts may be shipped JIT or JIS to the designated POS (33) at which the customer order originated.

The assembled BIW and related components (29) as referenced in FIG. 3 are transferred to an assembly rotisserie crane (34) allowing the POS technicians to ergonomically and safely assemble the vehicle. The assembly and functional check operations are manually performed from both sides of the assembly rotisserie crane.

The assembly process begins in step (34). In another embodiment the technicians assemble the vehicle using a manual sled. In still another embodiment an open cell fixture is used by the technicians to assemble the vehicle.

In a CAP the typical vehicle assembly process is sequenced depending upon the vehicle BOM encompassing the various BIW and the Non-BIW components as ordered by the customer. The present invention decouples the BIW assembly from the non-BIW assembly allowing for a grouping of component sets to be assembled at one station. In this illustrative embodiment eight assembly stations are configured up to final fluid fill and testing steps for a 2-door internal combustion engine (ICE) propulsion system. In another embodiment involving plug-in hybrid electric (PHEV) propulsion or battery electric (BEV) propulsion systems up to twelve stations are required for vehicle assembly.

At steps (35) and (36) non-BIW components are assembled by the POS technicians in accordance with the present embodiment. The use of the assembly rotisseries crane allows the technicians to assemble various mechanical and electrical component sets and to conduct a functional check at Step (37).

Referring to (38) and (39) the power train subassembly including, the engine, transmission, axles and related components is assembled and function tested (37). In this illustrative embodiment an ICE propulsion system is described. In another embodiment a

PHEV system is described. And in still another embodiment a BEV propulsion system is described.

At stations (40) and (41) the interior components are assembled and the functional check (37) is conducted.

At stations (42) and (43) the final BIW trim parts and the wheel sub-assemblies are installed.

At (44) the vehicle fluids fluid fill, air bag and customer convenience and safety systems are installed.

At (45) the vehicle is checked on a chassis dynamometer and subjected to a leak test.

At (46) the vehicle is available for customer pick-up or delivery. In the case of a sale to the designated POS sale can be arranged to a 3^{rd} party (e.g. another POS).

The invention reduces substantially the need to maintain physical stock of vehicles between the CAP and the IFD. That is, the invention does not require maintaining the industry norm of approximately sixty (60) days of vehicle stock.

The present invention allows the heretofore-impracticable and uneconomical separation of the BIW and vehicle assembly from the CAP to regional sites in near proximity to final customers.

While the present invention has been described in terms of particular embodiments and applications, in both summarized and detailed forms, it is not intended that these descriptions in any way limit its scope to any such embodiments and applications, and it will be understood that many substitutions, changes and variations in the described embodiments, applications and details of the method and system illustrated herein and of their operation can be made by those skilled in the art without departing from the spirit of this invention.

1. The invention outlines a decentralized regional process for manufacturing and assembly of production vehicles comprising a plurality of components, the said process comprising the steps of:
a) Fabrication of a vehicle's BIW components at a cohort of decentralized regional manufacturing sites;
b) Coordinated shipment of a vehicle's BIW components to a cohort of POS;
c) Coordinated shipment of a vehicle's non-BIW components and systems to a cohort of POS;
d) Assembly of the BIW components at the POS to form a production vehicle
e) Assembly of all other non-BIW components at the POS either as separate parts or modules to form a production vehicle;
f) Certification of a completed production vehicle at the POS; and
g) Arranging customer pickup or delivery of the production vehicle at POS.

2. The method of claim 1 further comprising allocating and fabricating specific BIW components at designated decentralized regional manufacturing sites;

3. The method of claim 1 further comprising the fabrication of BIW for a plurality of OEMs;

4. The method of claim 1 wherein a customer may also include retail, POS, rental, commercial fleet and/or specialty vehicle upfitters;

5. The method of claim 1 further comprising shipment of non-BIW components and systems to POS thru existing OEM logistics contractors:

6. The method of claim 1 wherein the final production vehicle sales transaction may take place in person, online, by phone or by other means of electronic communication between the customer and the POS;

7. The method of claim 1 wherein a cohort of POS can be designated to assemble production vehicles to meet market demand;

8. The method of claim 2 wherein the fabrication of BIW components may include sourcing and purchasing certain BIW components and parts from 3^{rd} parties;

9. The method of claim 2 wherein the fabrication of BIW components may include both original equipment (OE) and aftermarket (AM) parts;

10. The method of claim 3 wherein an individual POS may build and sell production vehicles to other POS locations.

11. The method of claim 3 wherein an individual POS may function as a pilot and pre-production vehicle production site on behalf of an OEM prior to production vehicle assembly process approval;

12. The method of claim 3 wherein an individual decentralized regional manufacturing site may function as a pilot and pre-production BIW production location on behalf of an OEM prior to production vehicle assembly process approval

13. The method of claim 3 wherein a POS may elect to have certain production vehicle parts and accessories installed outside its POS.
